(19) United States
(12) Patent Application Publication
(10) Pub. No.: US 2025/0253510 A1
(43) Pub. Date: Aug. 7, 2025

(54) MODE CONVERSION DEVICE

(71) Applicant: Panasonic Intellectual Property Management Co., Ltd., Osaka (JP)

(72) Inventors: Ken TAKAHASHI, Ishikawa (JP); Koji TAKINAMI, Kanagawa (JP); Tomohiro MURATA, Kanagawa (JP)

(21) Appl. No.: 18/857,086

(22) PCT Filed: Dec. 22, 2022
(86) PCT No.: PCT/JP2022/047315

§ 371 Date: Oct. 15, 2024

(30) Foreign Application Priority Data
May 26, 2022 (JP) 2022-085966

(51) Int. Cl. H01P 1/16; H01P 3/08

(52) U.S. Cl. CPC H01P 1/16; H01P 3/081

(57) ABSTRACT

A mode transition device according to an embodiment of the present disclosure comprises: a first dielectric substrate that has a microstrip line that is constituted by a line conductor and a first ground conductor that faces the line conductor, said first dielectric substrate having a first thickness; a second dielectric substrate that has a post wall waveguide that includes a first conductor layer that is connected to the line conductor in the same plane and a second conductor layer that faces the first conductor layer, said second dielectric substrate having a second thickness that is thicker than the first thickness; and a first via that electrically connects the first ground conductor and the second conductor layer.

### TECHNICAL FIELD

The present disclosure relates to a mode transition structure.

### BACKGROUND ART

A microstrip line is often used as a means that transmits a high-frequency signal on a dielectric substrate. However, in a frequency band such as a millimeter wave or a terahertz wave, transmission loss due to conductor loss is large because of an influence of a skin effect, which is a phenomenon specific to a high frequency, and interface unevenness.

The conductor loss can be reduced by increasing a thickness of a dielectric (substrate) included in the microstrip line, but in this case, radiation loss in radiation of energy an electromagnetic wave increases, and thus, it is difficult to reduce the transmission loss.

On the other hand, as a single means that reduces the transmission loss, there is a post-wall waveguide structure in which a dielectric is sandwiched between a pair of conductor layers, the conductor layers are electrically connected to each other via a group of via-holes arranged at an interval of λ/2 (λ: wavelength of an electromagnetic wave) in a transmission direction of a signal (a propagation direction of the electromagnetic wave), and a main conductor layer is used as a wide wall of a waveguide tube and the group of via-holes is used as a narrow wall of the waveguide tube. Since a post-wall waveguide is surrounded by conductors on four sides, the radiation loss does not increase even when the substrate thickness is increased. For this reason, it is possible to increase the thickness of the dielectric and to reduce the conductor loss and the radiation loss at the same time.

When mounting of an integrated circuit (IC) that generates a high-frequency signal is considered, the IC is often mounted on a microstrip line via a solder ball, and it is difficult to directly feed the post-wall waveguide with electric power. For this reason, in a case where the post-wall waveguide is used as the transmission path, a propagation (transmission) mode transition structure (hereinafter, simply referred to as a mode transition structure) that connects the microstrip line and the post-wall waveguide is configured. Note that, the term “mode transition structure” may be replaced with “mode transition apparatus” or the like.

As related art of the mode transition structure, for example, Patent Literature (hereinafter, abbreviated as “PTL”) 1 discloses a mode transition structure in which a line conductor of a microstrip line and a wide wall of a post-wall waveguide on one side are in the same plane, and a ground conductor (hereinafter, referred to as “GND”) of the microstrip line and a wide wall of the post-wall waveguide on another side are in the same plane (the microstrip line and the post-wall waveguide having the same thickness are connected to each other).

### CITATION LIST

### Patent Literature

### PTL 1

Japanese Patent Application Laid-Open No. 2004-153368

### SUMMARY OF INVENTION

In the related art described in PTL 1, however, the thicknesses of the microstrip line and the post-wall waveguide are the same, and thus, it is difficult to connect a microstrip line and a post-wall waveguide having different thicknesses to each other.

In the related art described in PTL 1, in a case where a thin microstrip line and a thin post-wall waveguide are connected to each other, radiation loss decreases and conductor loss increases, and in a case where a thick microstrip line and a thick post-wall waveguide are connected to each other, the conductor loss decreases and the radiation loss increases, and thus, it is difficult to reduce the radiation loss of the microstrip line or the conductor loss of the post-wall waveguide.

A non-limiting example of the present disclosure contributes to providing a mode transition structure capable of connecting a microstrip line and a post-wall waveguide having different thicknesses to each other while reducing transmission loss.

A mode transition structure according one exemplary embodiment of the present disclosure includes: a first dielectric substrate that includes a microstrip line including a line conductor and a first ground conductor facing the line conductor and that has a first thickness; a second dielectric substrate that includes a post-wall waveguide including a first conductor layer connected to the line conductor on a same plane and a second conductor layer facing the first conductor layer and that has a second thickness larger than the first thickness; and a first via that electrically connects the first ground conductor and the second conductor layer to each other.

According to one exemplary embodiment of the present disclosure, it is possible to connect a microstrip line and a post-wall waveguide having different thicknesses to each other while reducing transmission loss.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a perspective view illustrating a mode transition structure according to Embodiment 1 of the present disclosure;

FIG. 2 is a sectional side view illustrating the mode transition structure according to Embodiment 1 of the present disclosure;

FIG. 3 is a perspective view illustrating a mode transition structure according to a Comparative Example (an example of the related art);

FIG. 4 is a sectional side view illustrating the mode transition structure according to the Comparative Example;

FIG. 5 is a view illustrating radiation power simulation results of the mode transition structure according to Embodiment 1 of the present disclosure and the mode transition structure according to the Comparative Example;

FIG. 6 is a perspective view illustrating a mode transition structure according to Embodiment 2 of the present disclosure;

FIG. 7 is a sectional side view illustrating the mode transition structure according to Embodiment 2 of the present disclosure;

FIG. 8 is a view illustrating band-pass characteristic simulation results of the mode transition structure according to Embodiment 2 of the present disclosure and the mode transition structure according to the Comparative Example;

FIG. 9 is a perspective view illustrating a mode transition structure according to a variation of Embodiment 2 of the present disclosure;

FIG. 10 is a sectional side view illustrating the mode transition structure according to the variation of Embodiment 2 of the present disclosure;

FIG. 11 is a perspective view illustrating a mode transition structure according to Embodiment 3 of the present disclosure;

FIG. 12 is a sectional side view illustrating the mode transition structure according to Embodiment 3 of the present disclosure;

FIG. 13 is a view illustrating band-pass characteristic simulation results of the mode transition structure according to Embodiment 3 of the present disclosure and the mode transition structure according to the Comparative Example; and

FIG. 14 is a sectional side view illustrating a mode transition structure according to a variation of Embodiment 3 of the present disclosure.

### DESCRIPTION OF EMBODIMENTS

Hereinafter, embodiments of the present disclosure will be described in detail with appropriate reference to the drawings. However, any unnecessarily detailed description may be omitted. For example, detailed descriptions of already well-known matters and repeated descriptions for substantially the same configuration may be omitted. This is to avoid the unnecessary redundancy of the following description and to facilitate understanding of those skilled in the art.

Note that, the accompanying drawings and the following description are provided so that a person skilled in the art understands the present disclosure sufficiently, and are not intended to limit the subject matters recited in the claims.

In the present specification, a Z-axis positive direction illustrated in the drawings is referred to as up (direction), and a Z-axis negative direction is referred to as down (direction). Further, in order to facilitate understanding, some elements in the various drawings, such as a side plane (plane parallel to a YZ plane illustrated in the drawings) of a mode transition structure, may be omitted, and some elements may not be drawn to scale.

### Embodiment 1

### Configuration of Mode Transition Structure

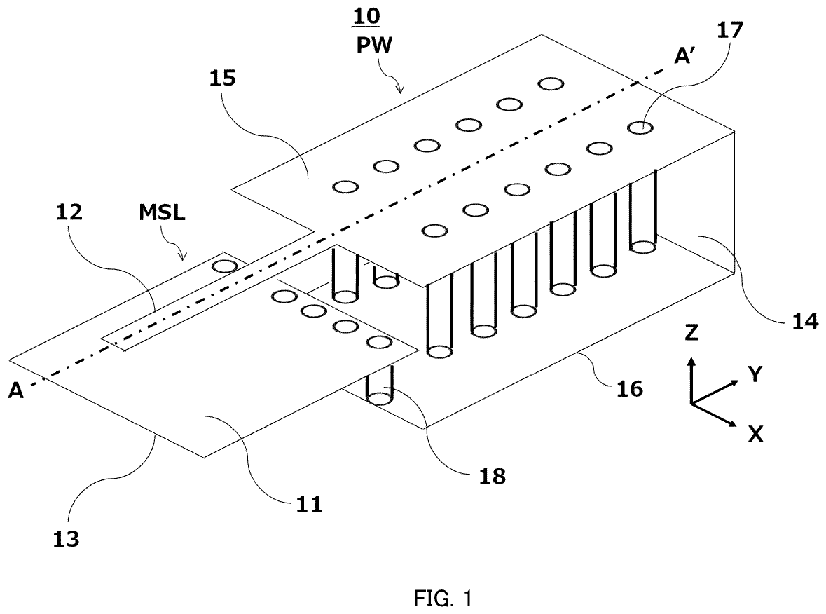

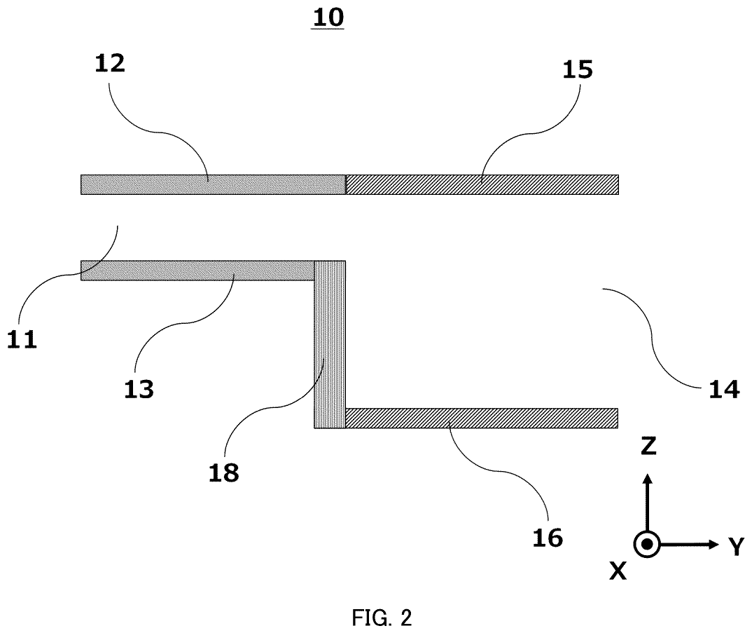

FIG. 1 is a perspective view illustrating mode transition structure 10 according to Embodiment 1 of the present disclosure, and FIG. 2 is a sectional side view (A-A′ sectional view) illustrating mode transition structure 10.

As illustrated in FIGS. 1 and 2, mode transition structure 10 includes first dielectric substrate 11 including microstrip line MSL, and second dielectric substrate 14 including post-wall waveguide PW. Here, a thickness of first dielectric substrate 11 (first thickness) and a thickness of second dielectric substrate 14 (second thickness) are different from each other (the thickness of second dielectric substrate 14 is larger than the thickness of first dielectric substrate 11).

Note that, the thickness of first dielectric substrate 11 may be referred to as a thickness of a dielectric included in first dielectric substrate 11 or a thickness of microstrip line MSL, and the thickness of second dielectric substrate 14 may be referred to as a thickness of a dielectric included in second dielectric substrate 14 or a thickness of post-wall waveguide PW. Note that, first dielectric substrate 11 and second dielectric substrate 14 may include one substrate or may include different substrates.

As illustrated in FIG. 1, microstrip line MSL includes first dielectric substrate 11, line conductor 12, and GND 13 (first ground conductor). Specifically, microstrip line MSL includes line conductor 12 and GND 13 facing each other with a dielectric interposed therebetween in first dielectric substrate 11.

As illustrated in FIG. 1, post-wall waveguide PW includes second dielectric substrate 14, first conductor layer 15, second conductor layer 16, and vias (via-holes) 17. Specifically, post-wall waveguide PW includes: first conductor layer 15 and second conductor layer 16 (forming a waveguide wide wall or simply a wide wall) that face each other with a dielectric interposed therebetween in second dielectric substrate 14; and vias 17 (forming a waveguide narrow wall or simply a narrow wall) that face each other and electrically connect the conductor layers to each other. Note that, vias 17 are arranged in a transmission direction of a signal (a propagation direction (transmission direction) of an electromagnetic wave; Y direction) at an interval equal to or less than half a wavelength (λ/2) of the electromagnetic wave.

As illustrated in FIG. 2, line conductor 12 and first conductor layer 15 are connected to each other on the same plane (a plane parallel to an XY plane).

As illustrated in FIGS. 1 and 2, vias (via-holes) 18 (first vias) electrically connect GND 13 and second conductor layer 16 (GND 13 and second conductor layer 16 are electrically connected via vias 18). Accordingly, unlike the related art, GND 13 and second conductor layer 16 are not connected to each other on the same plane (the plane parallel to the XY plane).

### COMPARATIVE EXAMPLE

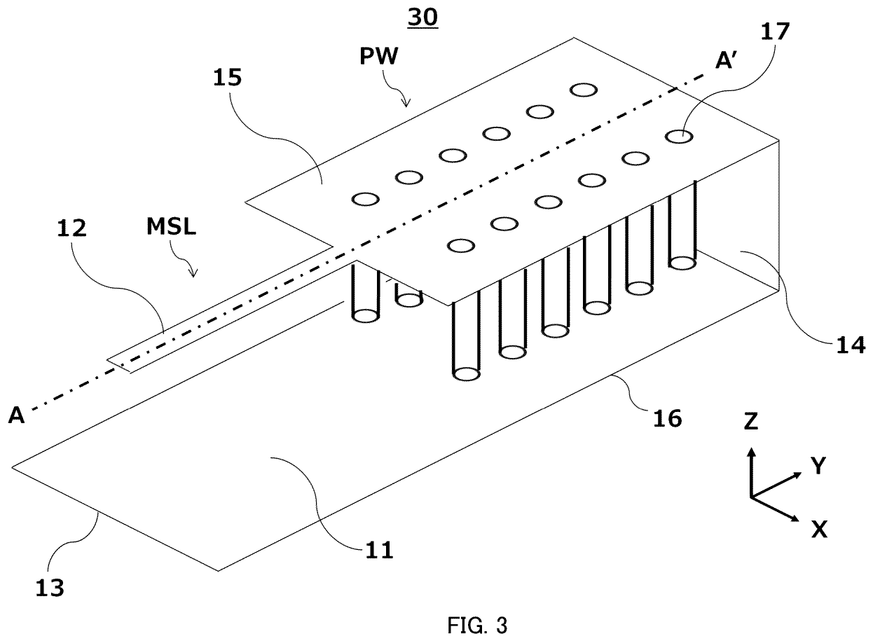

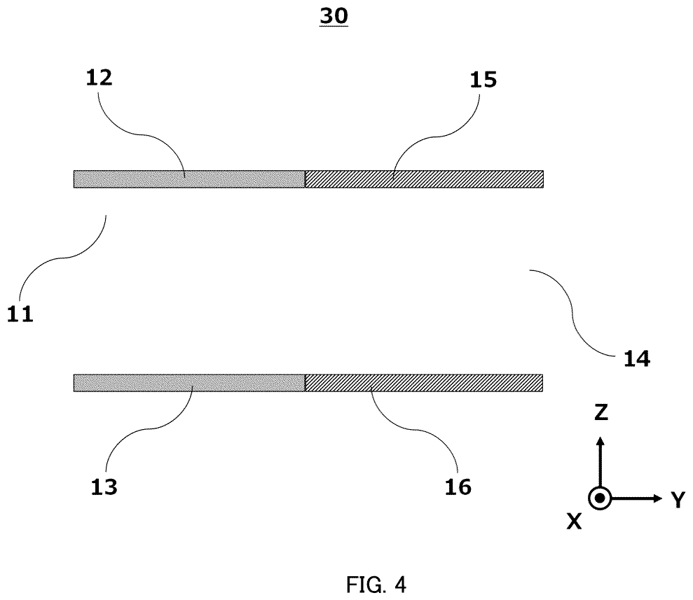

FIG. 3 is a perspective view illustrating mode transition structure 30 according to a Comparative Example, and FIG. 4 is a sectional side view (A-A′ sectional view) illustrating mode transition structure 30. Note that, in mode transition structure 30, the same elements as those in mode transition structure 10 are denoted by the same reference signs, and parts different from those in mode transition structure 10 will be described.

As illustrated in FIGS. 3 and 4, mode transition structure 30 includes first dielectric substrate 11 including microstrip line MSL, and second dielectric substrate 14 including post-wall waveguide PW. Unlike mode transition structure 10, in mode transition structure 30, the thicknesses of first dielectric substrate 11 and second dielectric substrate 14 are the same, GND 13 and second conductor layer 16 are present on the same plane (XY plane), and no via corresponding to vias 18 is present. Accordingly, mode transition structure 30 may be construed as an example of the related art based on a mode transition structure described in PTL 1.

### Comparison

The present inventors analyzed radiation power at 300 GHz in a case where a microstrip line with a thickness of 0.1 mm and a post-wall waveguide with a thickness of 0.2 mm are connected to each other by using mode transition structure 10 according to Example 1 (Embodiment 1) illustrated in FIG. 1, and in a case where a microstrip line with a thickness of 0.2 mm and a post-wall waveguide with a thickness of 0.2 mm are connected to each other by using mode transition structure 30 according to the Comparative Example (the example according to the related art) illustrated in FIG. 3, and compared the radiation losses, by means of an electromagnetic field simulation using a finite integration method.

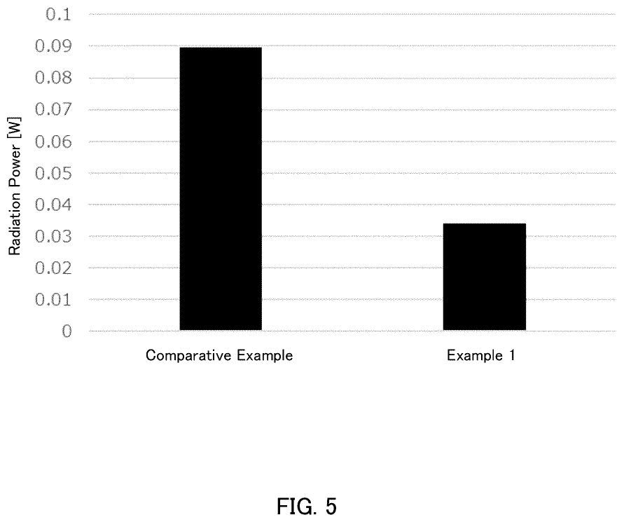

FIG. 5 is a view illustrating radiation power simulation results of mode transition structure 10 according to Example 1 and mode transition structure 30 according to the Comparative Example, which are obtained in a case where power of 0.5 W is inputted. It can be seen in FIG. 5 that mode transition structure 10 according to Example 1 has less power radiation into space than mode transition structure 30 according to Comparative Example 1, and that the radiation loss can be reduced. This is because the thickness of the microstrip line according to Example 1 is thinner than the thickness of the microstrip line according to the Comparative Example.

As described above, mode transition structure 10 may have a configuration in which the thickness of microstrip line MSL is not required to be the same as the thickness of post-wall waveguide PW, and thus, it is possible to reduce transmission loss and to connect microstrip line MSL and post-wall waveguide PW having different thicknesses of dielectric substrates to each other.

### Embodiment 2

### Configuration of Mode Transition Structure

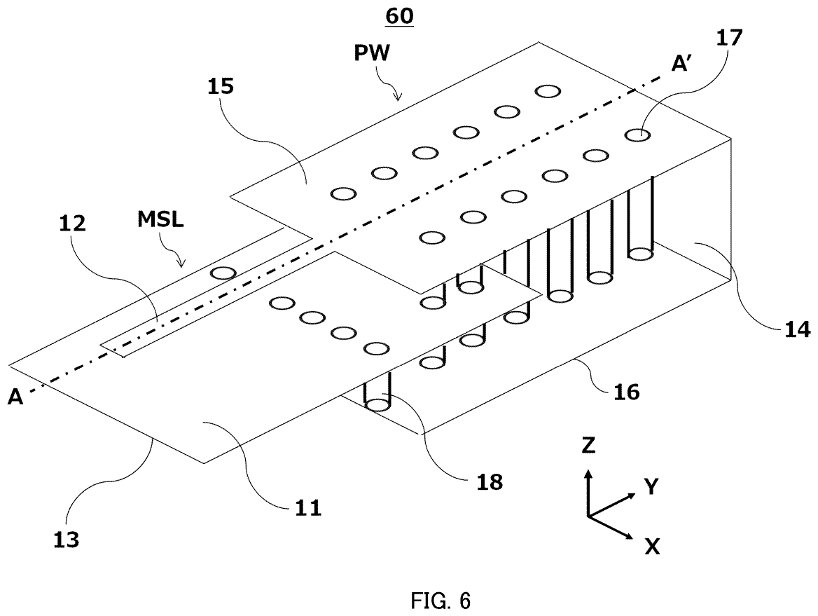

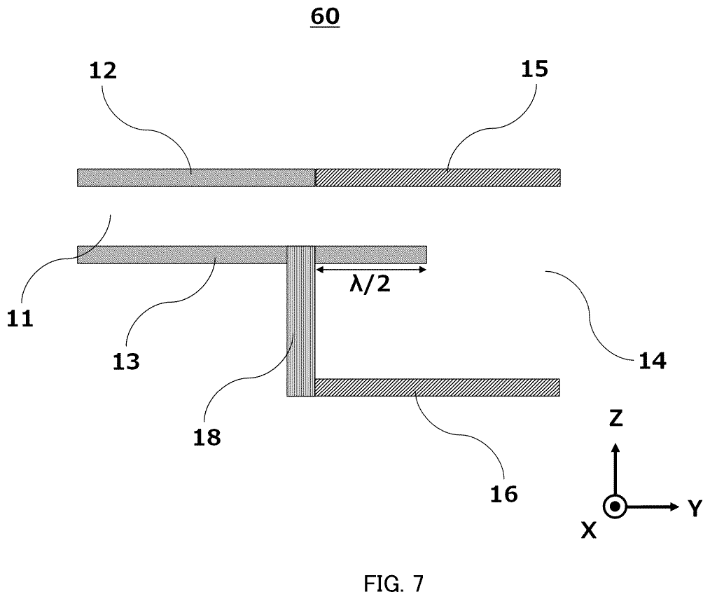

FIG. 6 is a perspective view illustrating mode transition structure 60 according to Embodiment 2 of the present disclosure, and FIG. 7 is a sectional side view (A-A′ sectional view) illustrating mode transition structure 60. Note that, in mode transition structure 60, the same elements as those in mode transition structure 10 are denoted by the same reference signs, and parts different from those in mode transition structure 10 will be described.

Unlike mode transition structure 10, in mode transition structure 60 as illustrated in FIG. 7, GND 13 disposed parallel to line conductor 12 is further disposed to extend (overlap) by substantially λ/2 between first conductor layer 15 and second conductor layer 16. GND 13 extends by substantially λ/2 in a direction of post-wall waveguide PW (Y-axis positive side) with reference to an end surface (a ZX plane perpendicular to a Y-axis) of vias 18. Vias 18 as seen in the Z-direction are disposed away from the end surface (end portion) of GND 13 in contact with post-wall waveguide PW, along the propagation direction of the electromagnetic wave (in a Y-axis negative direction) by substantially λ/2. In mode transition structure 60 illustrated in FIG. 7, GND 13, first conductor layer 15, and second conductor layer 16 are disposed to overlap with each other by substantially λ/2 in a YZ section.

Thus, the end surface of GND 13 (the end surface in contact with post-wall waveguide PW as seen in the Z-direction), vias 18, and second conductor layer 16 form a short stub and, thus, reflection of power is reduced and band-pass characteristics are improved.

### Comparison

The present inventors have analyzed and compared the band-pass characteristics of mode transition structures 60 according to Example 2 (Embodiment 2) illustrated in FIG. 6 and mode transition structure 30 according to the Comparative Example (the example of the related art) illustrated in FIG. 3, by means of the electromagnetic field simulation using the finite integration method.

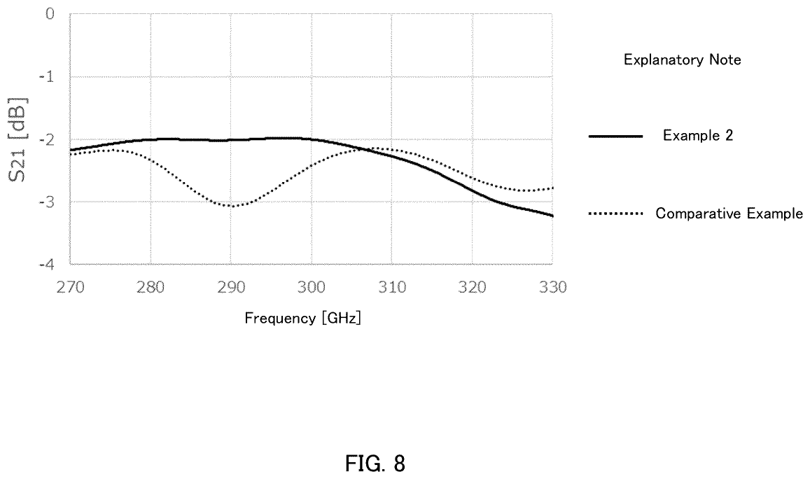

FIG. 8 is a view illustrating band-pass characteristic simulation results of mode transition structure 60 and mode transition structure 30. In FIG. 8, a horizontal axis represents a frequency (unit: GHz), and a vertical axis represents a value (unit: dB) of S21, which is an S parameter indicating the band-pass characteristics.

It can be seen in FIG. 8 that, in a case where the frequency is 300 GHz, mode transition structure 60 has a larger band-pass characteristic than that of mode transition structure 30.

### Variation

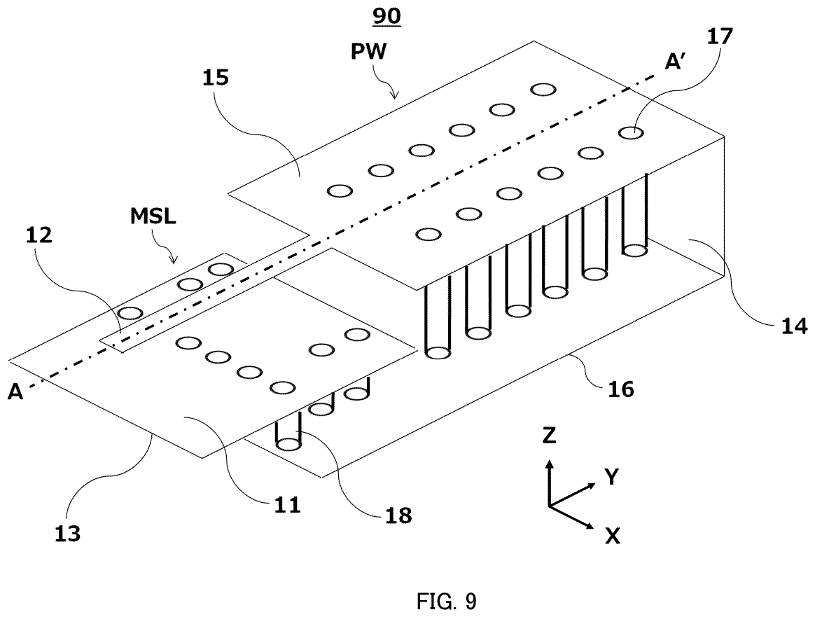

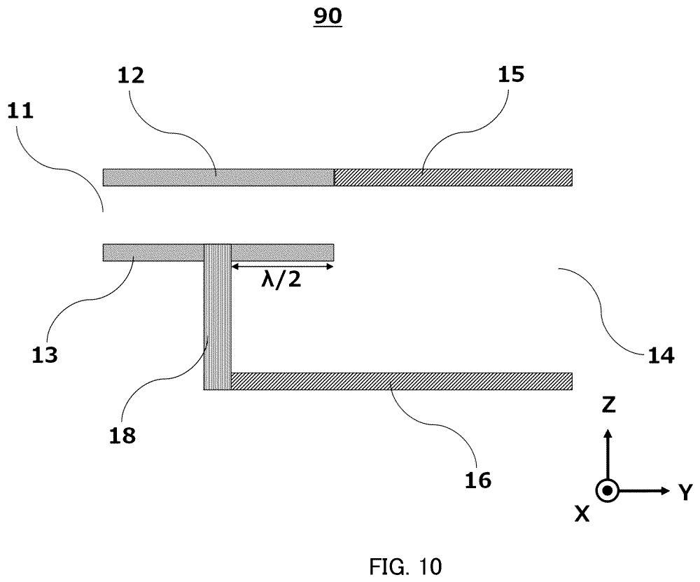

FIG. 9 is a perspective view illustrating mode transition structure 90 according to a variation of Embodiment 2 of the present disclosure, and FIG. 10 is a sectional side view (A-A′ sectional view) illustrating mode transition structure 90.

In the present variation, as illustrated in FIG. 10, as seen in the Z-direction (in the XY plane), main conductor layer (second conductor layer) 16 extends by substantially λ/2 in a direction from post-wall waveguide PW to microstrip line MSL (Y-axis negative direction) with reference to a connection plane between line conductor 12 and first conductor layer 15 (the ZX plane perpendicular to the Y axis), and positions of GND 13 and vias 18 in the Y-axis negative direction are offset by substantially λ/2 in the Y-axis negative direction as compared with the configuration of mode transition structure 60. In mode transition structure 90 illustrated in FIG. 10, line conductor 12, GND 13, and second conductor layer 16 are disposed to overlap with each other by substantially λ/2 in the YZ section. Also in this case, vias 18 as seen in the Z-direction (in the XY plane) are disposed away from the end surface of GND 13 in contact with post-wall waveguide PW, along the propagation direction of the electromagnetic wave (in the Y-axis negative direction) by substantially λ/2. Even in this structure, the end surface of GND 13 (the end surface in contact with post-wall waveguide PW as seen in the Z-direction), vias 18, and second conductor layer 16 form a short stub and, thus, the reflection of power is reduced and the band-pass characteristics are improved.

As described above, vias 18 need not be disposed at a position at which line conductor 12 of microstrip line MSL and first conductor layer 15 of post-wall waveguide PW are connected to each other, or immediately below the vicinity of such a position. The band-pass characteristics depend on a positional relationship between GND 13 of microstrip line MSL, second conductor layer 16 of post-wall waveguide PW, and vias 18.

### Embodiment 3

### Configuration of Mode Transition Structure

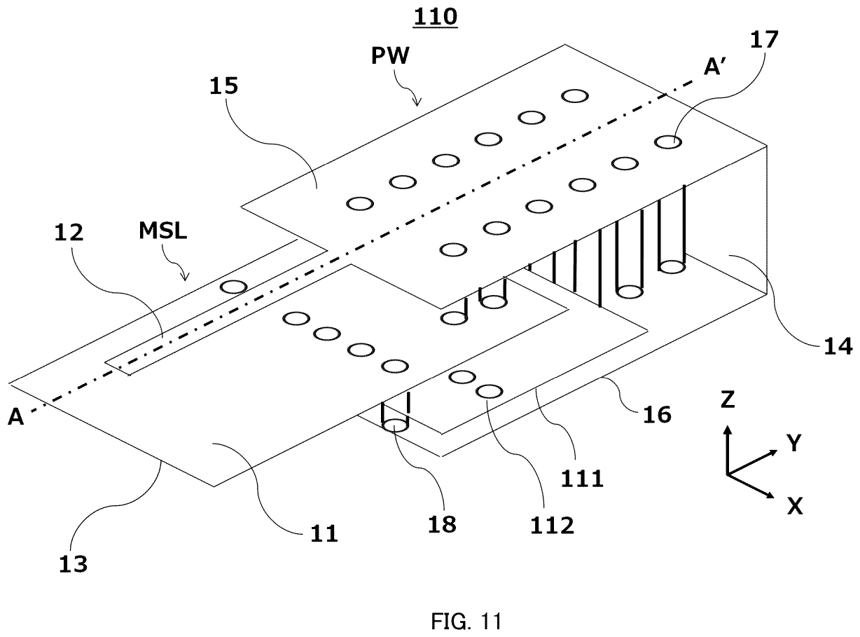

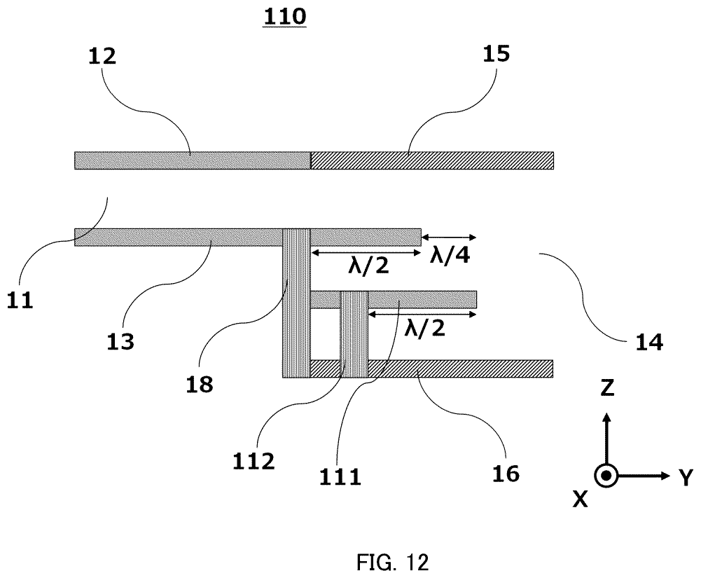

FIG. 11 is a perspective view illustrating mode transition structure 110 according to Embodiment 3 of the present disclosure, and FIG. 12 is a sectional side view (A-A′ sectional view) illustrating mode transition structure 110. Note that, in mode transition structure 110, the same elements as those in mode transition structure 60 are denoted by the same reference signs, and parts different from those in mode transition structure 60 will be described.

Unlike mode transition structure 60, in mode transition structure 110 as illustrated in FIGS. 11 and 12, GND 111 (second ground conductor) is provided between GND 13 and second conductor layer 16. Mode transition structure 110 includes GND 111 disposed between GND 13 and second conductor layer 16. Further, GND 111 as seen in the Z-direction (in the XY plane) extends from the end surface of vias 18 (the end surface in contact with post-wall waveguide PW as seen in the Z-direction), along the propagation direction of the electromagnetic wave by substantially 3λ/4. Accordingly, the end surface of GND 13 (the end surface in contact with post-wall waveguide PW as seen in the Z-direction) and the end surface of GND 111 (the end surface in contact with post-wall waveguide PW as seen in the Z-direction) as seen in the Z-direction are away from each other along the propagation direction of the electromagnetic wave by substantially λ/4. In mode transition structure 110 illustrated in FIG. 12, first conductor layer 15, GND 13, and second conductor layer 16 are disposed to overlap with each other by substantially λ/2 in the YZ section, first conductor layer 15, GND 111, and second conductor layer 16 are disposed to overlap with each other by substantially 3λ/4 in the YZ section, and GND 111 and GND 13 are disposed to overlap with each other by substantially λ/2 in the YZ section.

In addition, unlike mode transition structure 60, vias (via-holes) 112 (second vias) that electrically connect GND 111 and second conductor layer 16 to each other are provided as illustrated in FIGS. 11 and 12. Mode transition structure 110 includes vias 112 that electrically connect GND 111 and second conductor layer 16 to each other. Vias 112 as seen in the Z-direction are disposed away from the end surface of GND 111 (the end surface in contact with post-wall waveguide PW as seen in the Z-direction) along the propagation direction of the electromagnetic wave (in the Y-axis negative direction) by substantially λ/2.

As a result, the short stub formed by GND 13 and via 18 and a short stub formed by GND 111 and via 112 are laminated in a step shape.

As described above, by disposing the short stubs at the positions shifted from each other by substantially λ/4, it is possible to bring the phases of a reflection wave from the short stubs into antiphase. Thus, by canceling out the reflection waves, it is possible to reduce loss due to reflection and to further improve the band-pass characteristics of mode transition structure 110 (connector).

### Comparison

The present inventors have analyzed and compared the band-pass characteristics of mode transition structure 110 according to Example 3 (Embodiment 3) illustrated in FIG. 11 and mode transition structure 30 according to the Comparative Example (the example of the related art) illustrated in FIG. 3, by means of the electromagnetic field simulation using the finite integration method.

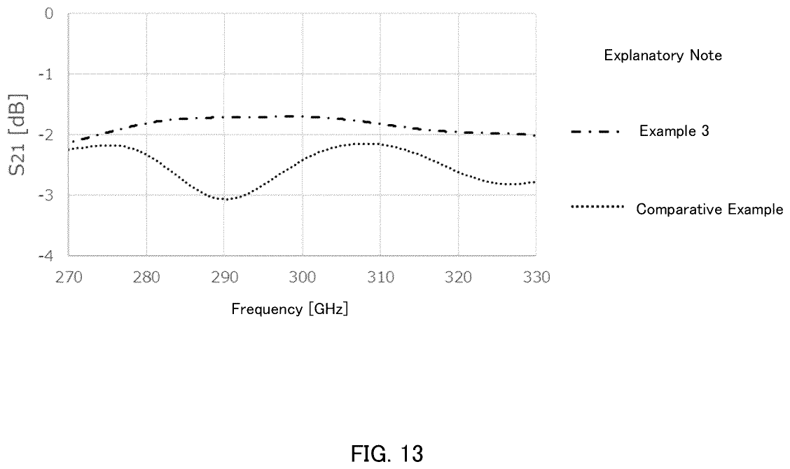

FIG. 13 is a view illustrating band-pass characteristic simulation results of mode transition structure 110 and mode transition structure 30. In FIG. 13, a horizontal axis represents a frequency (unit: GHz), and a vertical axis represents a value of S21 (unit: dB).

It can be seen in FIG. 13 that, in a case where the frequency is 300 GHz, mode transition structure 110 has a larger band-pass characteristic than that of mode transition structure 30.

### Variation

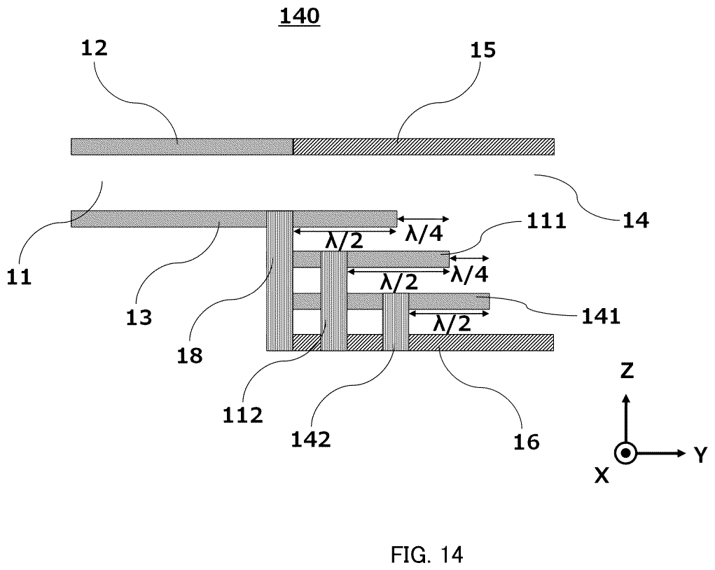

FIGS. 11 and 12 illustrate an example in which the short stubs are laminated in a step shape with two stages, but the number of stages is not limited. For example, as illustrated in FIG. 14 (a sectional side view of mode transition structure 140 according to a variation of Embodiment 3 of the present disclosure (corresponding to the A-A′ sectional views in other figures)), GND 141 and vias 142 may be added, and short stubs may be laminated in a step shape with three stages. Of course, in the same manner, a GND and a via may be added, and the short stubs may be laminated in a step shape with four or more stages.

For example, the mode transition structure may include n (n is an integer of 1 or more) GNDs (GND 111, GND 141, and the like) that are disposed between GND 13 and second conductor layer 16, and vias (second vias; vias 112, vias 142, and the like) that electrically connect each of the n GNDs and second conductor layer 16 to each other.

Further, the vias that electrically connect each of the n GNDs and second conductor layer 16 to each other, as seen in the Z-direction (in the XY plane), may be disposed away from the end surface (the end surface in contact with post-wall waveguide PW) of each of the n GNDs along the propagation direction of the electromagnetic wave by substantially λ/2. For example, in a case where n=2 as illustrated in FIG. 14, vias 112 that electrically connect GND 111 and second conductor layer 16, as seen in the Z-direction, may be disposed away from the end surface of GND 111 (the end surface in contact with post-wall waveguide PW) along the propagation direction of the electromagnetic wave by substantially λ/2. Further, for example, vias 142 that electrically connect GND 141 and second conductor layer 16, as seen in the Z-direction, may be disposed away from the end surface of GND 141 (the end surface in contact with post-wall waveguide PW) along the propagation direction of the electromagnetic wave by substantially λ/2.

Further, the end surfaces (the end surfaces in contact with post-wall waveguide PW) of each pair of GNDs facing each other among (n+1) GNDs consisting of GND 13 and the n GNDs, as seen in the Z-direction, may be away from each other along the propagation direction of the electromagnetic wave by substantially λ/4. For example, in a case where n=2 as illustrated in FIG. 14, the end surfaces (the end surfaces in contact with post-wall waveguide PW) of GND 13 and GND 111 as seen in the Z-direction, which are a pair of facing GNDs, may be away from each other along the propagation direction of the electromagnetic wave by substantially λ/4. Further, for example, the end surfaces of GND 111 and GND 141 (the end surfaces in contact with post-wall waveguide PW) as seen in the Z-direction, which are a pair of facing GNDs, may be away from each other along the propagation direction of the electromagnetic wave by substantially λ/4. In mode transition structure 140 illustrated in FIG. 14, first conductor layer 15, GND 13, and second conductor layer 16 are disposed to overlap with each other by substantially λ/2 in the YZ section, first conductor layer 15, GND 111, and second conductor layer 16 are disposed to overlap with each other by substantially 3λ/4 in the YZ section, first conductor layer 15, GND 141, and second conductor layer 16 are disposed to overlap with each other by substantially λ in the YZ section, GND 111 and GND 13 are disposed to overlap with each other by substantially λ/2 in the YZ plane, and GND 111 and GND 141 are disposed to overlap with each other by substantially 3λ/4 in the YZ section.

### Effect of Embodiment

The mode transition structure (mode transition structure 10, 60, 90, 110, or 140) according to an embodiment of the present disclosure includes: first dielectric substrate 11 that includes microstrip line MSL including line conductor 12 and GND 13 facing each other and that has a first thickness; second dielectric substrate 14 that includes post-wall waveguide PW including first conductor layer 15 and second conductor layer 16 facing each other and that has a second thickness larger than the first thickness; and vias 18 that electrically connect GND 13 and second conductor layer 16. Line conductor 12 and first conductor layer 15 are connected to each other on the same plane (the plane parallel to the XY plane).

With the configuration, it is not necessary to make the thickness of the microstrip line equal to the thickness of the post-wall waveguide, and thus, it is possible to reduce the transmission loss and to connect the microstrip line and the post-wall waveguide having different thicknesses to each other.

### Summary of Embodiment

The mode transition structure according one exemplary embodiment of the present disclosure includes: a first dielectric substrate that includes a microstrip line including a line conductor and a first ground conductor facing the line conductor and that has a first thickness; a second dielectric substrate that includes a post-wall waveguide including a first conductor layer connected to the line conductor on a same plane and a second conductor layer facing the first conductor layer and that has a second thickness larger than the first thickness; and a first via that electrically connects the first ground conductor and the second conductor layer to each other.

With the above-described configuration, it is not necessary to make the thickness of the microstrip line equal to the thickness of the post-wall waveguide, so that it is possible to reduce the transmission loss and to connect the microstrip line and the post-wall waveguide having different thicknesses to each other.

In the mode transition structure, the first via as seen in a direction perpendicular to the same plane is disposed away from an end portion of the first ground conductor by substantially half a wavelength of an electromagnetic wave along a propagation direction in which the electromagnetic wave propagates through the post-wall waveguide, the end portion being in contact with the post-wall waveguide.

With the above configuration, the end portion of the first ground conductor, the first via, and the second conductor layer form a short stub and, thus, the reflection of power is reduced and the band-pass characteristics can be improved.

The mode transition structure further includes: a second ground conductor that is disposed between the first ground conductor and the second conductor layer; and a second via that electrically connects the second ground conductor and the second conductor layer to each other, in which the second via as seen in the direction perpendicular to the same plane is disposed away from an end portion of the second ground conductor by substantially half the wavelength of the electromagnetic wave along the propagation direction, the end portion being in contact with the post-wall waveguide, and the end portion of the first ground conductor in contact with the post-wall waveguide and the end portion of the second ground conductor in contact with the post-wall waveguide as seen in the direction perpendicular to the same plane are away from each other by substantially one quarter of the wavelength of the electromagnetic wave.

With the above configuration, the short stubs are laminated, and the reflection waves from the short stubs are canceled out and it is thus possible to reduce the loss due to reflection and to further improve the band-pass characteristics.

The mode transition structure further includes: n ground conductors, where n is an integer equal to or greater than 1, that are disposed between the first ground conductor and the second conductor layer; and a second via that electrically connects a corresponding one of the n ground conductors and the second conductor layer to each other, in which the second via as seen in the direction perpendicular to the same plane is disposed away from an end portion of the corresponding one of the n ground conductors by substantially half the wavelength of the electromagnetic wave along the propagation direction, the end portion being in contact with the post-wall waveguide.

With the above configuration, the short stub is formed, so that the reflection of power is reduced and the band-pass characteristics can be improved.

In the mode transition structure, as seen in the direction perpendicular to the same plane, end portions of a pair of ground conductors facing each other among (n+1) ground conductors including the first ground conductor and the n ground conductors are away from each other by substantially one quarter of the wavelength of the electromagnetic wave, the end portions being in contact with the post-wall waveguide.

With the above configuration, the reflection waves from the short stub are canceled out and it is thus possible to reduce the loss due to reflection and to further improve the band-pass characteristics.

In the mode transition structure, the first ground conductor, the first conductor layer, and the second conductor layer as seen in a direction perpendicular to the same plane are disposed to overlap with one another by substantially half a wavelength of an electromagnetic wave along a propagation direction in which the electromagnetic wave propagates through the post-wall waveguide.

In the mode transition structure, the first ground conductor, the line conductor, and the second conductor layer as seen in a direction perpendicular to the same plane are disposed to overlap with one another by substantially half a wavelength of an electromagnetic wave along a propagation direction in which the electromagnetic wave propagates through the post-wall waveguide.

Although the embodiments have been described above with reference to the drawings, the present disclosure is not limited to these examples. Obviously, a person skilled in the art would arrive variations and modification examples within a scope described in claims. It is understood that these variations and modifications are within the technical scope of the present disclosure. Moreover, any combination of features of the above-mentioned embodiments may be made without departing from the spirit of the disclosure.

The disclosure of Japanese Patent Application No. 2022-085966, filed on May 26, 2022, including the specification, drawings and abstract, is incorporated herein by reference in its entirety.

### INDUSTRIAL APPLICABILITY

An example of the present disclosure is suitable for use in a mode transition structure that connects a microstrip line and a post-wall waveguide.

### REFERENCE SIGNS LIST

10 Mode transition structure
11 First dielectric substrate
12 Line conductor
13 Ground conductor
14 Second dielectric substrate
15 First conductor layer
16 Second conductor layer
17 Via (via-hole)
18 Via (via-hole)
30 Mode transition structure
60 Mode transition structure
90 Mode transition structure
110 Mode transition structure
111 Ground conductor
112 Via (via-hole)
140 Mode transition structure
141 Ground conductor
142 Via (via-hole)

1. A mode transition structure, comprising:
a first dielectric substrate that includes a microstrip line including a line conductor and a first ground conductor facing the line conductor and that has a first thickness;
a second dielectric substrate that includes a post-wall waveguide including a first conductor layer connected to the line conductor on a same plane and a second conductor layer facing the first conductor layer and that has a second thickness larger than the first thickness; and
a first via that electrically connects the first ground conductor and the second conductor layer to each other.

2. The mode transition structure according to claim 1, wherein
the first via as seen in a direction perpendicular to the same plane is disposed away from an end portion of the first ground conductor by substantially half a wavelength of an electromagnetic wave along a propagation direction in which the electromagnetic wave propagates through the post-wall waveguide, the end portion being in contact with the post-wall waveguide.

3. The mode transition structure according to claim 2, further comprising:
a second ground conductor that is disposed between the first ground conductor and the second conductor layer; and
a second via that electrically connects the second ground conductor and the second conductor layer to each other, wherein
the second via as seen in the direction perpendicular to the same plane is disposed away from an end portion of the second ground conductor by substantially half the wavelength of the electromagnetic wave along the propagation direction, the end portion being in contact with the post-wall waveguide, and
the end portion of the first ground conductor in contact with the post-wall waveguide and the end portion of the second ground conductor in contact with the post-wall waveguide as seen in the direction perpendicular to the same plane are away from each other by substantially one quarter of the wavelength of the electromagnetic wave.

4. The mode transition structure according to claim 2, further comprising:
n ground conductors, where n is an integer equal to or greater than 1, that are disposed between the first ground conductor and the second conductor layer; and
a second via that electrically connects a corresponding one of the n ground conductors and the second conductor layer to each other, wherein
the second via as seen in the direction perpendicular to the same plane is disposed away from an end portion of the corresponding one of the n ground conductors by substantially half the wavelength of the electromagnetic wave along the propagation direction, the end portion being in contact with the post-wall waveguide.

5. The mode transition structure according to claim 4, wherein
as seen in the direction perpendicular to the same plane, end portions of a pair of ground conductors facing each other among (n+1) ground conductors including the first ground conductor and the n ground conductors are away from each other by substantially one quarter of the wavelength of the electromagnetic wave, the end portions being in contact with the post-wall waveguide.

6. The mode transition structure according to claim 1, wherein
the first ground conductor, the first conductor layer, and the second conductor layer as seen in a direction perpendicular to the same plane are disposed to overlap with one another by substantially half a wavelength of an electromagnetic wave along a propagation direction in which the electromagnetic wave propagates through the post-wall waveguide.

7. The mode transition structure according to claim 1, wherein
the first ground conductor, the line conductor, and the second conductor layer as seen in a direction perpendicular to the same plane are disposed to overlap with one another by substantially half a wavelength of an electromagnetic wave along a propagation direction in which the electromagnetic wave propagates through the post-wall waveguide.
